(19) United States
(12) Patent Application Publication
(10) Pub. No.: US 2025/0074338 A1
(43) Pub. Date: Mar. 6, 2025

(54) BATTERY COVER

(71) Applicant: SUBARU CORPORATION, Tokyo (JP)

(72) Inventors: Naoya OSHIMA, Tokyo (JP); Masato MIYOSHI, Tokyo (JP); Yudai MIYAKE, Tokyo (JP)

(21) Appl. No.: 18/775,722

(22) Filed: Jul. 17, 2024

(30) Foreign Application Priority Data
Sep. 5, 2023 (JP) 2023-143821

(51) Int. Cl. B60R 13/08

(52) U.S. Cl. CPC B60R 13/0838

(57) ABSTRACT

A battery cover to be disposed in an engine room includes a cover wall configured to cover a side surface of a battery. A sound absorbing surface is provided on the cover wall. The sound absorbing surface includes a first sound absorbing layer and a second sound absorbing layer that are stacked in a thickness direction. The first sound absorbing layer is made of a first sound absorbing material for a first frequency band. The second sound absorbing layer is made of a second sound absorbing material for a second frequency band lower than the first frequency band.

### CROSS-REFERENCE TO RELATED APPLICATIONS

The present application claims priority from Japanese Patent Application No. 2023-143821 filed on Sep. 5, 2023, the entire contents of which are hereby incorporated by reference.

### BACKGROUND

The disclosure relates to a technical field of a battery cover attached to a battery mounted on a vehicle such as an automobile.

Some vehicles such as automobiles include a battery cover attached to a battery mounted in an engine room (see, for example, Japanese Unexamined Patent Application Publication (JP-A) No. 2014-231885).

### SUMMARY

An aspect of the disclosure provides a battery cover to be disposed in an engine room includes a cover wall configured to cover a side surface of a battery. A sound absorbing surface is provided on the cover wall. The sound absorbing surface includes a first sound absorbing layer and a second sound absorbing layer that are stacked in a thickness direction. The first sound absorbing layer is made of a first sound absorbing material for a first frequency band. The second sound absorbing layer is made of a second sound absorbing material for a second frequency band lower than the first frequency band.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 illustrates an embodiment of a battery cover according to an aspect of the disclosure together with FIGS. 2 and 3, and FIG. 1 is a schematic plan view illustrating an engine room.

FIG. 2 is a perspective view of the battery cover.

FIG. 3 is a cross-sectional view of the battery cover.

### DETAILED DESCRIPTION

A battery disposed in an engine room together with an engine may be degraded or malfunction due to a temperature change caused by heat generated by the engine, or the like. However, the battery cover as disclosed in JP-A No. 2014-231885 is attached, so that an influence of the temperature change around the battery is reduced.

Recently, regulation on noise of a vehicle has been promoted. In one example, it is desirable for a vehicle including an engine (internal combustion engine) as a drive source to easily emit sounds from a drive source as compared with a vehicle (electric vehicle) that simply uses a motor driven by electric power as a drive source, and to reduce noise that leaks outside the vehicle from an engine room.

It is desirable to reduce the noise that leaks outside the vehicle from the engine room.

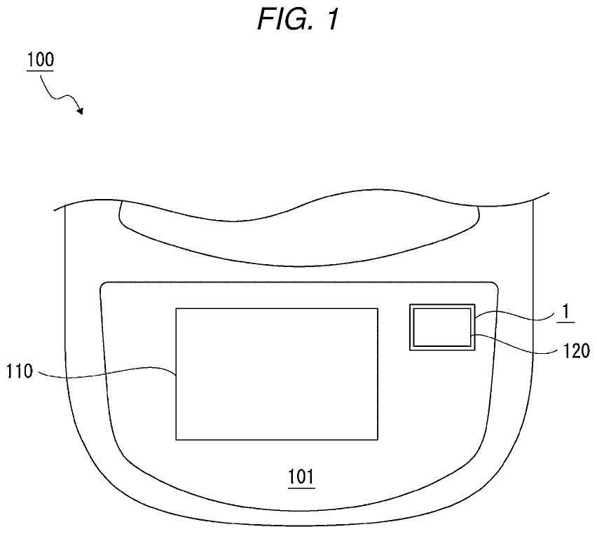

Hereinafter, an embodiment for implementing a battery cover of the disclosure will be described with reference to the attached drawings (FIGS. 1 to 3). Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

In the following description, a forward direction of a vehicle is referred to as a forward direction, and a front-rear direction, an up-down direction, and a left-right direction are indicated. It is noted that the directions of the front-rear direction, the up-down direction, and the left-right direction illustrated hereinafter are described for convenience of explanation, and the directions are not limited thereto when the disclosure is implemented.

### Schematic Configuration of Engine Room

First, a schematic configuration of an engine room of a vehicle on which a battery cover is mounted will be described.

A vehicle 100 has an engine room 101, for example, in front of a vehicle cabin (see FIG. 1). An engine 110, a battery 120, and a battery cover 1 are disposed in the engine room 101. An engine hood (not illustrated) that can be opened and closed is provided above the engine room 101.

The engine 110 is disposed substantially in a center of the engine room 101, and is used as a power source of the vehicle 100. The vehicle 100 may be a vehicle traveling by power from fuel (gasoline), or may be a hybrid vehicle including a drive motor in addition to the engine 110 and traveling by at least one of the power from fuel or power from electricity.

The battery 120 is disposed rearward, for example, on a left side of the engine 110 in the engine room 101. The battery 120 serves as a power supply for each unit operated by electric power in the vehicle 100. The battery 120 has a rectangular box shape, and the battery cover 1 is attached in a manner of covering side surfaces of the battery 120.

### Configuration of Battery Cover

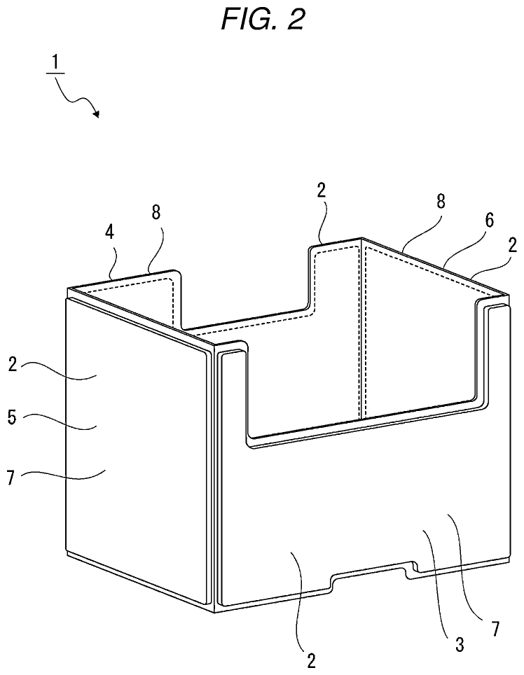

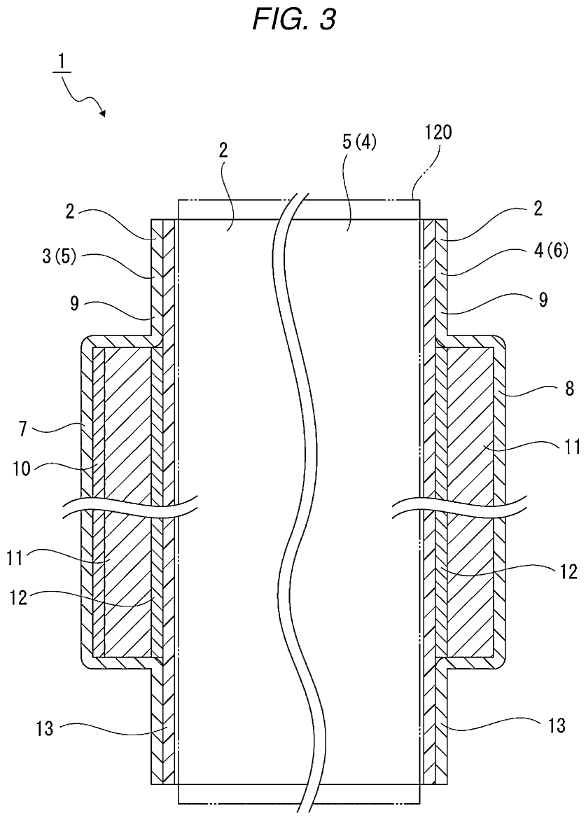

Next, a configuration of the battery cover 1 will be described (see FIGS. 2 and 3).

The battery cover 1 has a rectangular tube shape whose axial direction is the up-down direction, and includes four cover walls 2 that respectively cover the side surfaces of the battery 120 from four sides (see FIG. 2).

The cover walls 2 include a front surface 3 and a rear surface 4 that are disposed in the front-rear direction in a manner of being separated from each other in the front-rear direction, and includes a right side surface 5 and a left side surface 6 that are disposed in the left-right direction in a manner of being separated from each other in the left-right direction. Both of front and rear ends of the right side surface 5 are coupled to a right end of the front surface 3 and a right end of the rear surface 4, respectively, and both of front and rear ends of the left side surface 6 are coupled to a left end of the front surface 3 and a left end of the rear surface 4, respectively. The battery cover 1 is attached to the battery 120 in a state in which at least a part of the right side surface 5 faces the engine 110.

The front surface 3 and the right side surface 5 of the cover wall 2 have sound absorbing surfaces 7, and the rear surface 4 and the left side surface 6 of the cover wall 2 have support surfaces 8.

The sound absorbing surface 7 has, for example, a five-layer structure. An outer member 9, a first sound absorbing layer 10, a second sound absorbing layer 11, a protective layer 12, and an inner member 13 are stacked in this order from the outside in a thickness direction (see FIG. 3). An adhesive or an adhesive sheet may be provided between the stacked layers.

The outer member 9 and the inner member 13 are made of the same material, and are made of, for example, a polyester nonwoven fabric. Sizes of the outer member 9 and the inner member 13 are larger than those of the first sound absorbing layer 10, the second sound absorbing layer 11, and the protective layer 12 in a surface direction, and an outer edge of the outer member 9 and an outer edge of the inner member 13 are subjected to thermally compression bonding. In the sound absorbing surface 7, the first sound absorbing layer 10, the second sound absorbing layer 11, and the protective layer 12 are held by the outer member 9 and the inner member 13 from opposite sides.

The first sound absorbing layer 10 is made of a material having sound absorbing characteristics mainly for, for example, a frequency band of 1000 Hz or higher (first frequency band), such as an aluminum film. As the first sound absorbing layer 10, copper, lead, silver, gold, platinum, or the like may be used. The higher a specific gravity of a metal used, the higher sound absorbing performance of the first sound absorbing layer 10 can be ensured.

The second sound absorbing layer 11 is made of a material having sound absorbing characteristics for a frequency band lower than that of the first sound absorbing layer 10, for example, a frequency band (second frequency band) mainly equal to or less than 1000 Hz, such as urethane. The second sound absorbing layer 11 is thicker than the first sound absorbing layer 10, and is held by the outer member 9 and the inner member 13 in a state of being compressed in the thickness direction. Since the second sound absorbing layer 11 is compressed in the thickness direction, a thickness of the cover wall 2 is reduced, which makes it difficult to increase a size of the battery cover 1. As the second sound absorbing layer 11, a foamed material or a rubber material other than urethane may be used.

The protective layer 12 is made of a material having corrosion resistance to a battery liquid (dilute sulfuric acid), and as the protective layer 12, for example, the same aluminum film as the first sound absorbing layer 10 is used. The protective layer 12 has substantially the same thickness and size as the first sound absorbing layer 10. Similar to the first sound absorbing layer 10, copper, lead, silver, gold, platinum, or the like may be used as the protective layer 12, and the protective layer 12 and the first sound absorbing layer 10 may be made of different materials. As an ionization tendency of the metal used as the protective layer 12 is reduced, the higher corrosion resistance to the battery liquid can be ensured.

The support surface 8 has, for example, a four-layer structure. The outer member 9, the second sound absorbing layer 11, the protective layer 12, and the inner member 13 are stacked in this order from the outside in the thickness direction. In the support surface 8, the second sound absorbing layer 11 and the protective layer 12 are held by the outer member 9 and the inner member 13 from opposite sides. Each layer of the support surface 8 has a configuration similar to that of the sound absorbing surface 7.

As described above, in the battery cover 1, the sound absorbing surfaces 7 including the first sound absorbing layer 10 and the second sound absorbing layer 11 stacked in the thickness direction are provided, the first sound absorbing layer 10 is made of the sound absorbing material for the first frequency band, and the second sound absorbing layer 11 is made of the sound absorbing material for the second frequency band lower than the first frequency band.

Therefore, since sounds in different frequency bands are absorbed by the first sound absorbing layer 10 and the second sound absorbing layer 11, a sound in a wide range of frequency emitted from the engine 110 is absorbed by the battery cover 1, so that noise that leaks outside the vehicle from the engine room 101 can be reduced.

In the engine room 101, at least a part of the sound absorbing surface 7 (right side surface 5) faces the engine 110. Therefore, the sound emitted from the engine 110 easily reaches the sound absorbing surface 7, and thus, a favorable sound absorbing state of the battery cover 1 can be ensured.

In addition, the front surface 3 of the battery cover 1 is also provided as the sound absorbing surface 7. Of the four cover walls 2, the cover walls 2 disposed on sides closer to the engine 110 serve as the sound absorbing surfaces 7. Accordingly, a sound emitted from the engine 110 in a radial manner easily reaches either one of the sound absorbing surfaces 7, and thus, a better sound absorbing state of the battery cover 1 can be ensured.

In the battery cover 1, the first sound absorbing layer 10 is disposed outwardly of the second sound absorbing layer 11. The higher the frequency (shorter the wavelength) of the sound, the more likely the sound is to be reflected. Conversely, the lower the frequency (longer the wavelength) of the sound, the higher transmissive the sound is. Therefore, with the above-described configuration, a sound in the first frequency band is easily absorbed by the first sound absorbing layer 10 without being reflected, and a sound in the second frequency band transmits through the first sound absorbing layer 10 and is absorbed by the second sound absorbing layer 11, and thus, high sound absorbing performance of the battery cover 1 can be ensured.

Further, the protective layer 12 is provided inwardly of the second sound absorbing layer 11. Accordingly, by any chance, when the battery liquid leaks from the battery 120, the protective layer 12 protects the second sound absorbing layer 11 from the battery liquid. Therefore, the second sound absorbing layer 11 is prevented from being dissolved or degraded by the battery liquid, and it is possible to prolong a life of the battery cover 1.

The protective layer 12 is made of the same material as the first sound absorbing layer 10. Accordingly, it is not necessary to separately prepare dedicated materials for the protective layer 12 and the first sound absorbing layer 10, and thus, manufacturability of the battery cover 1 can be improved.

In the battery cover 1, the aluminum film is used as the first sound absorbing layer 10, and urethane is used as the second sound absorbing layer 11. Accordingly, a weight of the battery cover 1 can be reduced, and noise can be reduced without a significant increase in manufacturing cost.

In the above, the example is illustrated in which the sound absorbing surfaces are made of the sound absorbing materials for the two different frequency bands. Alternatively, the sound absorbing surfaces may be made of the sound absorbing materials for three or more different frequency bands.

By changing a combination of a thickness and a material of the first sound absorbing layer and the second sound absorbing layer, a frequency band of a sound to be absorbed by the sound absorbing surface can be set to any value.

According to the disclosure, since sounds in different frequency bands are absorbed by the first sound absorbing layer and the second sound absorbing layer, a sound in a wide range of frequency is absorbed by the battery cover, and noise that leaks outside the vehicle from the engine room can be reduced.

Accordingly, the first sound absorbing layer and the second sound absorbing layer absorb sounds in different frequency bands.

1. A battery cover to be disposed in an engine room, the battery cover comprising:
a cover wall configured to cover a side surface of a battery, wherein
a sound absorbing surface is provided on the cover wall, the sound absorbing surface comprising a first sound absorbing layer and a second sound absorbing layer that are stacked in a thickness direction,
the first sound absorbing layer is made of a first sound absorbing material for a first frequency band, and
the second sound absorbing layer is made of a second sound absorbing material for a second frequency band lower than the first frequency band.

2. The battery cover according to claim 1, wherein at least a part of the sound absorbing surface is configured to face an engine.

3. The battery cover according to claim 1, wherein the first sound absorbing layer is disposed outwardly of the second sound absorbing layer.

4. The battery cover according to claim 2, wherein the first sound absorbing layer is disposed outwardly of the second sound absorbing layer.

5. The battery cover according to claim 3, wherein a protective layer is provided inwardly of the second sound absorbing layer, the protective layer being configured to protect the second sound absorbing layer from a battery liquid of the battery.

6. The battery cover according to claim 4, wherein a protective layer is provided inwardly of the second sound absorbing layer, the protective layer being configured to protect the second sound absorbing layer from a battery liquid of the battery.

7. The battery cover according to claim 5, wherein the first sound absorbing layer and the protective layer are made of a same material.

8. The battery cover according to claim 6, wherein the first sound absorbing layer and the protective layer are made of a same material.
